(19) United States
(12) Patent Application Publication
(10) Pub. No.: US 2006/0092362 A1
(43) Pub. Date: May 4, 2006

(54) Continuous domain in-plane switching liquid crystal display

(75) Inventors: Tze-Min Lin, Miao-Li (TW); Chueh-Ju Chen, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/250,960

(22) Filed: Oct. 14, 2005

(30) Foreign Application Priority Data
Oct. 29, 2004 (CN) 200410091932.8

(51) Int. Cl. G02F 1/1343

(52) U.S. Cl. 349/141

(57) ABSTRACT

An IPS (in-plane switching) liquid crystal display (20) includes a first substrate (201), a second substrate (202), liquid crystal molecules (203) filled between the first and second substrates, and gate lines (211) and data lines (212) formed on the first substrate. The gate lines and data lines define pixel regions arranged in a matrix. Each pixel region includes pixel electrodes (233), common electrodes (243), and a TFT (220), and the pixel and common electrodes have a generally curved shape. At least one of the pixel and common electrodes together define a bend region having a smooth concave side and an opposite substantially rectilinear side. This IPS LCD provides equally fine visual performance at various different viewing angles.

### FIELD OF THE INVENTION

The present invention relates to liquid crystal display (LCD) devices, and more particularly to an in-plane switching (IPS) mode thin film transistor (TFT) LCD having continuous domains.

### BACKGROUND

A liquid crystal display utilizes the optical and electrical anisotropy of liquid crystal molecules to produce an image. The liquid crystal molecules have a particular passive orientation when no voltage is applied thereto. However, in a driven state, the liquid crystal molecules change their orientation according to the strength and direction of the driving electric field. A polarization state of incident light changes when the light transmits through the liquid crystal molecules, due to the optical anisotropy of the liquid crystal molecules. The extent of the change depends on the orientation of the liquid crystal molecules. Thus, by properly controlling the driving electric field, an orientation of the liquid crystal molecules is changed and a desired image can be produced.

The first type of LCD developed was the TN (twisted nematic) mode LCD. Even though TN mode LCDs have been put into use in many applications, they have an inherent drawback that cannot be eliminated; namely, a very narrow viewing angle. By adding compensation films on TN mode LCDs, this problem can be mitigated to some extent. However, the cost of the TN mode LCD is increased. Therefore, a totally different driving means called IPS (in-plane switching) was proposed as early as 1974. Then in 1993, Hitachi Corporation filed its first US patent application concerning IPS, in which an IPS mode LCD was disclosed.

A typical IPS mode LCD has an upper substrate, a lower substrate, and a liquid crystal layer interposed therebetween. The liquid crystal layer has a plurality of liquid crystal molecules which have a like orientation when not driven, this orientation being parallel to the substrates. Pixel electrodes and common electrodes are disposed on the lower substrate. When a voltage is applied to the electrodes, an electric field is generated between the electrodes. The electric field drives the liquid crystal molecules to rotate, so that they have a new orientation that is still parallel to the substrates. The change in orientation results in a change in light transmission. In other words, the operation of the IPS mode LCD is such that the liquid crystal molecules rotate in a plane parallel with the substrates in order to fulfill optical switching. The displayed image has the important advantage of a wide viewing angle. In basic IPS mode LCDs, the pixel electrodes and the common electrodes are each comb-shaped. The electric field of these LCDs in a driven state is along a certain direction. When the displayed image is viewed at different oblique angles, an observer notices a large color shift.

Referring to FIG. 4, this is a schematic plan representation of a pixel area P of a typical IPS liquid crystal display. The pixel area P includes a gate line 113 arranged in a first direction, a data line 115 and a common line 135 both arranged substantially in a second direction orthogonal to the first direction, a TFT (thin film transistor) 120 positioned at an intersection of the data line 115 and the gate line 113, a pixel electrode 131, and a common electrode 133. The TFT 120 has a gate electrode 121, a source electrode 123, and a drain electrode 125, which are connected with the gate line 113, the data line 115, and the pixel electrode 131 respectively. The pixel electrode 131 and the common electrode 133 are spaced apart from each other. The pixel and common electrodes 131, 133 are each comb-shaped, with the teeth thereof being generally zigzagged. Portions of the teeth of the pixel and common electrodes 131, 133 that are parallel to each other in a first direction form a first sub-electrode group. Portions of the teeth of the pixel and common electrodes 131, 133 that are parallel to each other in a second direction form a second sub-electrode group.

When a voltage is applied, because the pixel and common electrodes 131, 133 have the zigzagged structures, the electric field (not shown) generated is mainly along two directions. Turning to FIG. 5, the upper portion thereof shows part of the first sub-electrode group, and the lower portion thereof shows part of the second sub-electrode group. The liquid crystal molecules 130 in the upper and lower portions have different orientations, and the LCD exhibits a two-domain display effect. When viewing the LCD display from any oblique angle, the color shifts generated by the two domains counteract, and thus the overall color shift of the display is small.

However, at junctions of the first and second sub-electrode groups, the electric field is abnormal, and the liquid crystal molecules thereat cannot be driven properly. In other words, a disclination of the liquid crystal molecules is generated at the bends of the teeth of the pixel and common electrodes 131, 133. Light thereat cannot transmit properly, and the contrast ratio of the pixel area is lowered. Furthermore, the two-domain electrode configuration of the LCD inherently limits the display thereof. Equally good visual performance at various viewing angles cannot be attained.

What is needed, therefore, is a continuous-domain IPS liquid crystal display which has good visual performance at various viewing angles.

### SUMMARY

In a preferred embodiment, a continuous domain IPS liquid crystal display includes a first substrate, a second substrate, liquid crystal molecules filled between the first and second substrates, and gate lines and data lines formed at the second substrate. The gate lines and data lines define pixel regions that are arranged in a matrix. Each pixel region includes pixel electrodes, common electrodes, and a TFT. The pixel and common electrodes have a generally curved shape. At least one pair of adjacent pixel and common electrodes together define a bend region having a smooth concave side and a substantially rectilinear side.

The pixel and common electrodes have bends that include rectilinear sides, but the combined effect of adjacent bends of the pixel and common electrodes is a substantially smoothly curved configuration. Therefore when an electric field is applied, disclination of the liquid crystal molecules between the pixel and common electrodes does not occur, and the contrast ratio of the IPS LCD is unimpaired. Furthermore, because the pixel and common electrodes have the generally curved shape, the electric field generated by them is substantially a smooth continuum of multiple domains. Thus the IPS LCD provides equally fine visual performance at various viewing angles.

Other advantages and novel features will become more apparent from the following detailed description when taken in conjunction with the accompanying drawings.

### BRIEF DESCRIPTION OF THE DRAWINGS

FIG. 1 is a schematic, top elevation of a pixel region of an IPS LCD according to a first embodiment of the present invention.

FIG. 2 is a schematic, abbreviated, side cross-sectional view taken along line II-II of FIG. 1.

FIG. 3 is an enlarged view of a circled portion III of FIG. 1, showing approximate orientations of liquid crystal molecules when the IPS LCD is in a driven state.

FIG. 4 is a top cross-sectional view of a pixel region of a conventional IPS LCD.

FIG. 5 is essentially an enlarged view of a circled portion V of FIG. 4.

### DETAILED DESCRIPTION OF PREFERRED EMBODIMENTS

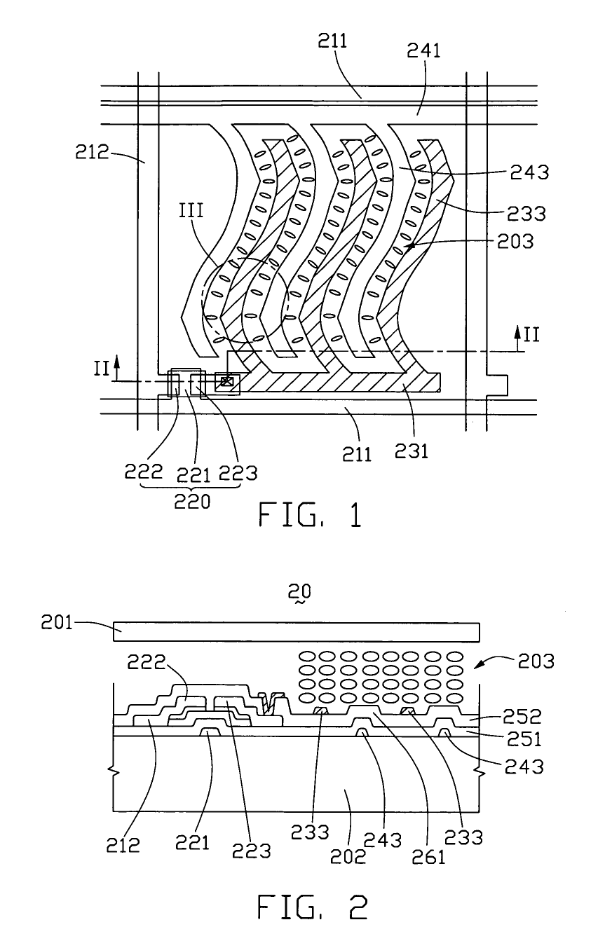

Referring to FIGS. 1-2, an in-plane switching liquid crystal display (IPS LCD) 20 according to a preferred embodiment of the present invention includes a first substrate 201, a second substrate 202 opposite to the first substrate 201, positive liquid crystal molecules 203 interposed between the first and second substrates 201 and 202, and a plurality of gate lines 211 and data lines 212 formed on the second substrate 202. The gate lines 211 and the data lines 212 define a multiplicity of pixel regions arranged in a matrix.

Each pixel region includes a TFT (thin film transistor) 220, a common line 241, a pixel line 231, several common electrodes 243, and several pixel electrodes 233.

The TFT 220 is positioned at an intersection of one of the gate lines 211 and one of the data lines 212. The TFT 220 has a gate electrode 221 connected to the gate line 211, a source electrode 222 connected to the data line 212, and a drain electrode 223 electrically connected to the pixel electrodes 233 through the pixel line 231. The common line 213 is disposed on an inner surface of the second substrate 202, and connects to the common electrodes 243. A gate insulating layer 251 covers the common electrodes 243. A passivative layer 252 covers the gate insulating layer 251. The pixel line 231 is disposed on the passivative layer 252, and connects to the pixel electrodes 233.

The pixel electrodes 233 and the common electrodes 243 have a like generally wavy shape, and are spaced a uniform distance apart from each other. Each of the pixel and common electrodes 233,243 include several bends. Each bend has a smooth concave side and an opposite substantially rectilinear side. The pixel and common electrodes 233, 243 can be made of a metallic material or a transparent conductive material such as ITO (indium tin oxide) or IZO (indium zinc oxide). The IPS LCD 20 has a higher aperture ratio if the pixel and common electrodes 233, 243 are transparent. Alternatively, the pixel and common electrodes 233 and 243 may be generally arcuate in shape.

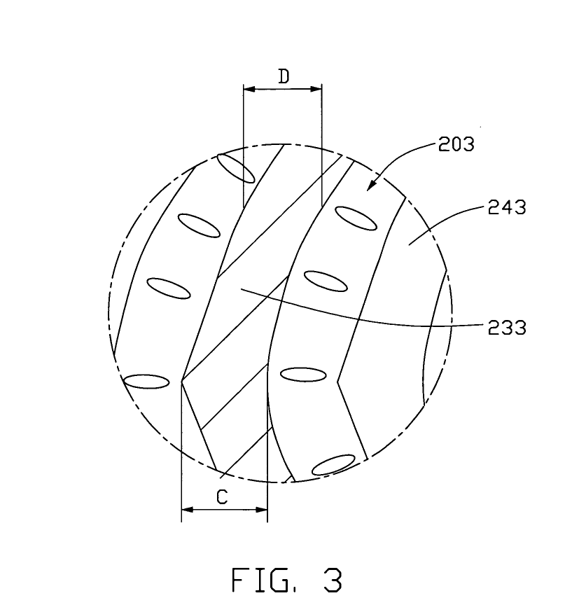

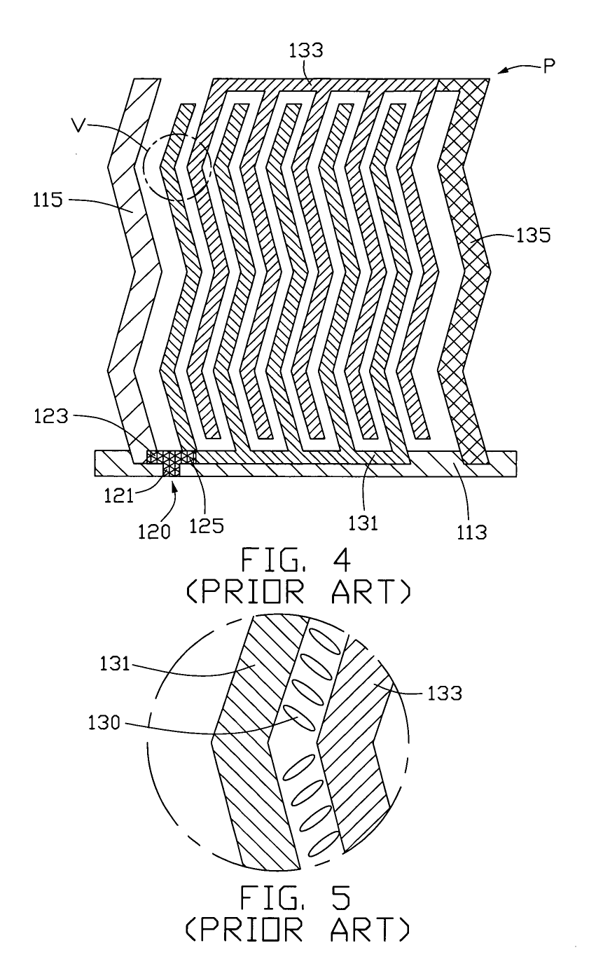

In operation, a voltage control signal is provided to the gate electrode 221 of the TFT 220 via the gate lines 211 to turn on the TFT 220, and display signals are provided to the pixel electrode 233 from the data line 212 via the source and drain electrodes 222, 223. Even though the pixel electrodes 233 and the common electrodes 243 are not on the same layer, a driving electric field is generated that is substantially parallel to the first and second substrates 201, 202. The positive liquid crystal molecules 203 align parallel with the electric field. FIG. 3 shows structures of parts of the pixel and common electrodes 233, 243, and approximate orientations of the liquid crystal molecules 203 in the driven state as described above.

The pixel and common electrodes 233, 243 have a generally wavy shape, and the electric field generated by them is substantially a smooth continuum of multiple domains. In addition, each of the bends of each of the pixel and common electrodes 233, 244 has a smooth concave side and an opposite substantially rectilinear side. A middle of each of the bends of the pixel or common electrodes 233, 243 has a maximum width C. Any other part of each bend of the pixel or common electrodes 233, 243 defines a width D, which is measured along a line parallel to the width C. The width C is greater than the width D. That is, a distance between the middles of adjacent bends of the pixel and common electrodes 233, 243 is less than a distance between any other parts of the adjacent bends. Thereby, the electric field is prevented from concentrating at the middles of the adjacent bends, thus avoiding an abnormal electric field thereat.

The pixel and common electrodes 233, 243 have the bends that include rectilinear sides, but the combined effect of adjacent bends of the pixel and common electrodes 233, 243 is a substantially smoothly curved configuration. Therefore disclination of the liquid crystal molecules 203 does not occur, and the contrast ratio of the IPS LCD 20 is unimpaired. Furthermore, because the pixel and common electrodes 233, 243 have the generally wavy shape, the electric field generated by them is substantially a smooth continuum of multiple domains, and the IPS LCD 20 provides equally fine visual performance at various viewing angles.

It is to be understood, however, that even though numerous characteristics and advantages of preferred embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An in-plane switching (IPS) liquid crystal display, comprising:
a first substrate and a second substrate;
liquid crystal molecules interposed between the first and second substrates; and
a plurality of gate lines and data lines formed on the second substrate, thereby defining a multiplicity of pixel regions; wherein
a pixel electrode, a common electrode, and a TFT (thin film transistor) are provided in each pixel region, the pixel and common electrodes having a generally curved shape; and
in each pixel region, the pixel and common electrodes together define a bend region having a concave side and an opposite substantially rectilinear side.

2. The IPS liquid crystal display as claimed in claim 1, wherein in each pixel region, the pixel and common electrodes have a generally wavy shape.

3. The IPS liquid crystal display as claimed in claim 2, wherein in each pixel region, the pixel and common electrodes are generally spaced a uniform distance apart from each other.

4. The IPS liquid crystal display as claimed in claim 1, wherein in each pixel region, the pixel and common electrodes have a generally arcuate shape.

5. The IPS liquid crystal display as claimed in claim 1, further comprising at least one common line at the second substrate.

6. The IPS liquid crystal display as claimed in claim 5, wherein the common line is parallel with a corresponding one of the gate lines at each pixel region, and is connected with the common electrode of the pixel region.

7. The IPS liquid crystal display as claimed in claim 6, further comprising at least one pixel line at the second substrate, wherein at each pixel region the pixel line connects the pixel electrode with a drain electrode of the TFT.

8. The IPS liquid crystal display as claimed in claim 7, wherein in each pixel region, the pixel and common electrodes are made from indium tin oxide.

9. The IPS liquid crystal display as claimed in claim 7, wherein in each pixel region, the pixel and common electrodes are made from indium zinc oxide.

10. An IPS (in-plane switching) liquid crystal display, comprising:
a pixel matrix substrate defining a plurality of pixel regions;
wherein each pixel region comprises one or more pixel electrodes and one or more common electrodes, and the pixel electrodes and the common electrodes have a similar generally curved shape and are generally uniformly spaced apart from each other, and at least one pair of adjacent pixel and common electrodes together define a bend region having a concave side and an opposite rectilinear side.

11. The IPS liquid crystal display as claimed in claim 10, wherein the pair of adjacent pixel and common electrodes have a generally wavy shape.

12. The IPS liquid crystal display as claimed in claim 10, wherein the pair of adjacent pixel and common electrodes have a generally arcuate shape.

13. The IPS liquid crystal display as claimed in claim 10, further comprising at least one common line at the pixel matrix substrate, the common line connecting with the common electrodes.

14. The IPS liquid crystal display as claimed in claim 13, further comprising at least one pixel line at the pixel matrix substrate, the pixel line connecting with the pixel electrodes.

15. An IPS (in-plane switching) liquid crystal display, comprising:
a pixel matrix substrate comprising a plurality of pixel regions;
wherein each pixel region comprises at least one pixel electrode and at least one common electrode, at least one pair of adjacent pixel and common electrodes together defining a bend region having a concave side and an opposite rectilinear side, whereby an electric field generated by the pair of adjacent pixel and common electrodes has at least two directions, and a transition from one of the directions to an adjacent one or more of the directions is smooth.

16. The IPS liquid crystal display as claimed in claim 15, wherein the pair of adjacent pixel and common electrodes have a generally curved shape, for facilitating the smooth transition of directions.

17. The IPS liquid crystal display as claimed in claim 15, wherein the pair of adjacent pixel and common electrodes have a generally wavy shape, for facilitating the smooth transition of directions to be substantially cyclical.
